(19) United States
(12) Patent Application Publication
(10) Pub. No.: US 2013/0078529 A1
(43) Pub. Date: Mar. 28, 2013

(54) ELECTROLYTE ADDITIVE FOR IMPROVING HIGH TEMPERATURE PERFORMANCE OF LITHIUM ION BATTERIES AND LITHIUM ION BATTERIES COMPRISING THE SAME

(71) Applicant: HEFEI GUOXUAN HIGH-TECH POWER ENERGY CO., LTD., Hefei (CN)

(72) Inventors: Xulai Yang, Hefei (CN); Yan Chen, Hefei (CN); Chengshi Liu, Hefei (CN); Dajun Liu, Hefei (CN); Yu Zhang, Hefei (CN)

(73) Assignee: HEFEI GUOXUAN HIGH-TECH POWER ENERGY CO., LTD., Hefei (CN)

(21) Appl. No.: 13/623,555

(22) Filed: Sep. 20, 2012

(30) Foreign Application Priority Data
Sep. 22, 2011 (CN) 201110282114.6

(51) Int. Cl. H01M 10/056; H01M 4/13

(52) U.S. Cl. 429/326; 429/209; 429/339; 429/336; 429/207

(57) ABSTRACT

A lithium ion battery includes a first electrode made of a cathodic material; a second electrode made of an anodic material; an electrolyte solution; and an additive added to the electrolyte solution, wherein the additive comprises a conjugated system and a bi-functional hydrogen bonding moiety. The additive includes a −OH group and an N atom. The additive includes a compound having a structure shown as follows:

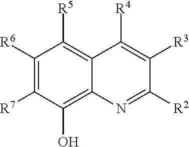

wherein R², R³, R⁴, R⁵, R⁶, and R⁷ are each independently selected from H, halogen, —OH, —NH₂, —NO₂, —CN, —CHO, —Si(CH₃)₃,—NH-alkyl, —O-alkyl, or an alkyl, wherein the alkyl group is C₁-C₁₂ alkyl; preferably, C₁-C₆ alkyl; more preferably C₁-C₃ alkyl; and wherein the alkyl group may be optionally substituted with one or more substituents selected from —OH, —NH₂, —NO₂, —CN, —CHO.

### CROSS REFERENCE TO RELATED APPLICATIONS

This claims the priority of Chinese Patent Application No. 201110282114.6, filed on Sep. 22, 2011, the disclosure of which is incorporated by reference in its entirety.

### BACKGROUND OF INVENTION

1. Field of the Invention

The present invention relates to the field of lithium ion batteries, particularly to materials for electrolytes of lithium ion batteries.

2. Background Art

In modem days, electric vehicles are well known for its efficiency. Electric vehicles (EVs) represent a cost saving choice, as compared to the gasoline-powered cars, due to their advantages, such as silent engine and zero emission, which is friendly to the environment. However, electric vehicles can only be as good as their batteries. Batteries have always been the Achilles heels of electric vehicles.

Currently, lithium-ion batteries are the most suitable existing technology for EVs because they can output high energy and power per unit of battery mass, allowing them to be lighter and smaller than other rechargeable batteries. Other advantages of lithium-ion batteries, as compared to lead acid and nickel metal hydride batteries, include high-energy efficiency, no memory effects, and a relatively long cycle life. However, just as other batteries, lithium ion batteries also degrade during storage or use. Temperature is the most significant factor contributing to the degradation of lithium ion batteries. Lithium ion batteries degrade much faster if stored or used at higher temperatures.

In addition, the presence of impurities, such as acids (e.g. HF) in the electrolytes, is a problem encountered in electrolyte cells. HF may be derived from certain lithium salts (e.g. LiPF₆) that are used in the batteries. The acids, which form readily at elevated temperatures, are responsible for cathode dissolution, which reduces the electrochemical performance of the cells. LiMn₂O₄, LiCoO₂, LiFePO₄, and LiNi_{0.5}Mn_{1.5}O₄ have similar problems. Cathode dissolution is primarily responsible for capacity fading of lithium ion batteries at elevated temperatures. However, elevated temperatures are unavoidable when the batteries are used at higher ambient temperatures or are charged-discharged at high rates.

Fortunately, the cycling stabilities of the cells improve significantly when LiPF₆ electrolyte salt is replaced with LiBOB or LiB(C₂O₄)₂ salts, which does not produce HF and can folio a complex with metal ions. Addition of (CH₃)₃SiNHSi(CH₃)₃ results in less capacity fading of the cathode and drastically reduces Mn dissolution. Tris(2,2,2-trifluoroethyl)phosphite, pyridine, dimethyl acetamide, and hexamethylphosphoramide can significantly improve the thermal stabilities of LiPF₆-based electrolytes of Li-ion cells by suppressing the formation of HF.

In addition, researchers also reported inorganic additives, such as NH₄I and calcium carbonate, may be used to suppress the adverse effects of HF and to improve cell performances. Reference is made to J. Power Sources, 2001, 99:60-65; J. Power Sources, 2009, 189(1):685-688; Electrochem. Solid-State Lett., 2002, 5(9): A206-A208; J. Electrochem. Soc., 2005, 152(7): A1361-A1365; J. Power Sources, 2007, 168: 258-264; J. Power Sources, 2003, 119-121:378-382; U.S. Patent No. 5,707,760; J. Power Sources, 2004, 129:14-19; J. Electrochem. Soc., 2005, 152(6): A1041-A1046; and Electrochem. Communica, 2005, 7:669-673. The disclosures of these are incorporated by reference in their entireties.

While these prior approaches have improved the performance of lithium ion batteries, there is still a need for new electrolyte solutions for lithium ion batteries to improve the battery performance, especially improvement in cycle life at higher temperatures.

### SUMMARY OF INVENTION

Embodiments of the present invention are made in consideration of the problems of the prior art. Embodiments of the invention relate to rechargeable lithium ion batteries having improved properties. Embodiments of the invention also relate to lithium-ion batteries each comprising a first electrolyte made of a cathode material, a second electrode made of an anodic material and an electrolyte solution, wherein the electrolyte solution comprises a functional additive. In accordance with embodiments of the invention, the additives can suppress the dissolution of metal ions from cathode materials so that cell performances, especially cycle performance at elevated temperature, can be substantially improved.

One aspect of the invention relates to lithium ion batteries. A lithium ion battery in accordance with one embodiment of the invention includes a first electrode made of a cathodic material; a second electrode made of an anodic material; an electrolyte solution; and an additive added to the electrolyte solution, wherein the additive comprises a conjugated system and a bi-functional hydrogen bonding moiety.

In accordance with some embodiments of the invention, the additive may include a —OH group and an N atom. For example, the additive may include a compound having a structure shown as follows:

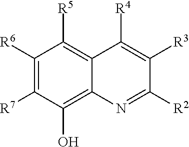

wherein R², R³, R⁴, R⁵, R⁶, and R⁷ are each independently selected from H, halogen, —OH, —NH₂, —NO₂, —CN, —CHO, —Si(CH₃)₃, —NH-alkyl, —O-alkyl, or an alkyl, wherein the alkyl group is C₁-C₁₂ alkyl; preferably, C₁-C₆ alkyl; more preferably C₁-C₃ alkyl; and wherein the alkyl group may be optionally substituted with one or more substituents selected from —OH, —NH₂, —NO₂, —CN, —CHO.

In accordance with embodiments of the invention, the additive compounds may work in following manners: first, neutralizing the acids (e.g. HF) to reduce the cathode dissolution in electrolytes; second, capturing H₂O with hydrogen bond to decrease the effect of water on LiPF₆ decomposition. These two mechanisms allow the additive compounds to act as stabilizing agents of LiPF₆. In addition, these additive compounds act by a third mechanism—i.e., as chelating reagents of the metal ions so that dissolved metal ions can't be reduced on the anode surface.

### BRIEF DESCRIPTION OF DRAWINGS

A complete appreciation of the invention will be readily obtained by reference to the following detailed description and the accompanying drawings.

FIG. 1 shows voltammograms, illustrating the charge and discharge characteristics of lithium ion batteries with and without an additive in the electrolyte solution in accordance with one embodiment of the invention.

FIG. 2 shows voltammograms, illustrating the formation of a solid electrolyte interface (SET) film on a graphite electrode of a lithium ion battery with an additive in the electrolyte solution in accordance with one embodiment of the invention.

FIG. 3 shows linear sweep voltammograms, illustrating suppression of electrolyte oxidation by an additive in the electrolyte solution in accordance with one embodiment of the invention.

FIG. 4A shows charge-and-discharge curves of LiNi_{0.5}Mn_{1.5}O₄//Li half cell, illustrating capacity fading of a function of charge-discharge cycles of a lithium ion battery without an additive in the electrolyte solution. FIG. 4B shows charge-and-discharge curves, illustrating capacity fading of a function of charge-discharge cycles of a lithium ion battery with an additive in the electrolyte solution in accordance with one embodiment of the invention.

FIG. 5 shows the cycle life performance of LiFePO4//graphite cells at 60° C., illustrating the capacity retention of lithium ion batteries with and without an additive in the electrolyte solution at elevated temperature in accordance with one embodiment of the invention.

FIG. 6 shows the cycle performance of LiFePO₄//graphite cells at 23° C., illustrating the effect of an additive in the electrolyte solution on the battery room temperature cycle performance in accordance with one embodiment of the invention.

### DEFINITION

As used herein, the term “cathodic material” or “cathode active material” refers to a material that is suitable for use as or on a cathode of a lithium ion battery. Any suitable materials known in the art may be used with embodiments of the invention. Examples of such materials may include lithium iron phosphate (LFP), lithium iron phosphate with carbon coating (LFP/C), lithium manganese oxide (LMO), lithium cobalt oxide (LCO), lithium nickel manganese cobalt oxide (NMC), lithium nickel cobalt aluminum oxide (NCA), etc.

As used herein, the term “anodic material” or “anode active material” refers to a material that is suitable for use as or on an anode of a lithium ion battery. Any suitable materials known in the art may be used with embodiments of the invention. Examples of such materials may include graphite, lithium titanate (LTO), etc.

As used herein, the term “electrolyte solution” refers to an electrolyte solution typically used in lithium ion batteries. An electrolyte solution for lithium ion batteries typically contains lithium salts in organic solvents. Any suitable electrolytes known in the art may be used with embodiments of the invention. The lithium salt may be any one of lithium hexafluorophosphate (LiPF₆), lithium hexafluoroarsenate monohydrate (LiAsF₆), lithium perchlorate (LiClO₄), lithium bis(oxalate)borate(LiBOB), lithium tetrafluoroborate (LiBF₄), lithium triflate (LiCF₃SO₃), or a combination thereof. The lithium salt may be used at a concentration of 0.8 mol/L to 1.5 mol/L. The solvent may contain carbonate compounds like ethyl carbonate(EC), diethyl carbonate(DEC), methyl ethyl carbonate(EMC), propylene carbonate(PC), and so on.

As used herein, the term “bi-functional hydrogen bonding moiety” refers to a moiety of a molecule that can participate in dual hydrogen bonding interactions both as a hydrogen bond donor and a hydrogen bond acceptor.

Note that disclosure of numerical ranges in the present description does intend to include individual numbers within the range, i.e., as if they were individually disclosed.

### DETAILED DESCRIPTION

Having described the present invention in general terms, a further understanding of the invention can be obtained with reference to specific preferred embodiments, which are provided herein for the purpose of illustration only and are not intended to limit the scope of the invention.

Embodiments of the present invention relate to lithium ion batteries with improved performance. In accordance with embodiments of the invention, electrolytes of such batteries contain additives that can prevent or slow acid formation from electrolytes. Acid formation can lead to cathode dissolution, which in turn degrades the performance of the batteries. These additives may be referred to as stabilizing agents. By having additives that can prevent or slow acid formation, batteries of the invention have higher performance, e.g., cycling performance and high-temperature performance.

In accordance with embodiments of the invention, additives for use with lithium ion batteries are compounds having a bidentate moiety. The bidentate moiety may function as a bifunctional hydrogen bonding moiety, which contains an H donor and an H acceptor. Preferably, the two functional groups participating in the hydrogen bonding are linked by a conjugated system. Examples of such compounds include 8-hydroxyquinoline (HQ, quinolinol, or oxine) or other oxine-like compounds such as 4-hydroxybenzimidazole or analogs thereof.

Embodiments of the invention preferably use oxine (8-hydroxyquinoline) or oxine-like compounds (e.g., compounds containing an 8-hydroxyquinoline moiety) as additives. An oxine contains a —OH and an amino group or an equivalent (e.g., pyridine) in the same molecule. A general formula of an oxine analog that can be used with embodiments of the invention is shown as follows:

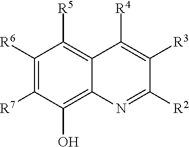

wherein R², R³, R⁴, R⁵, R⁶, and R⁷ are each independently selected from H, halogen, —OH, —NH₂, —NO₂, —CN, —CHO, —Si(CH₃)₃, —NH-alkyl, —O-alkyl, or an alkyl, wherein the alkyl group is C₁-C₁₂ alkyl; preferably, C₁-C₆ alkyl; more preferably C₁-C₃ alkyl; and wherein the alkyl group may be optionally substituted with one or more substituents selected from —OH, —NH₂, —NO₂, —CN, —CHO.

When R², R³, R⁴, R⁵, R⁶, and R⁷ are all hydrogen, the compound is 8-hydroxyquinoline (HQ or quinolinol), which has the following structure:

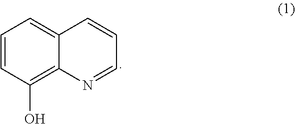 [SMILES: Oc1cccc2cccnc12]

In addition to HQ, various other 8-hydroxyquinoline analogs are also commercially available (e.g., from Sigma Aldrich, St. Louis, Mo.) as shown below. These and other analogs may also be used with embodiments of the invention.

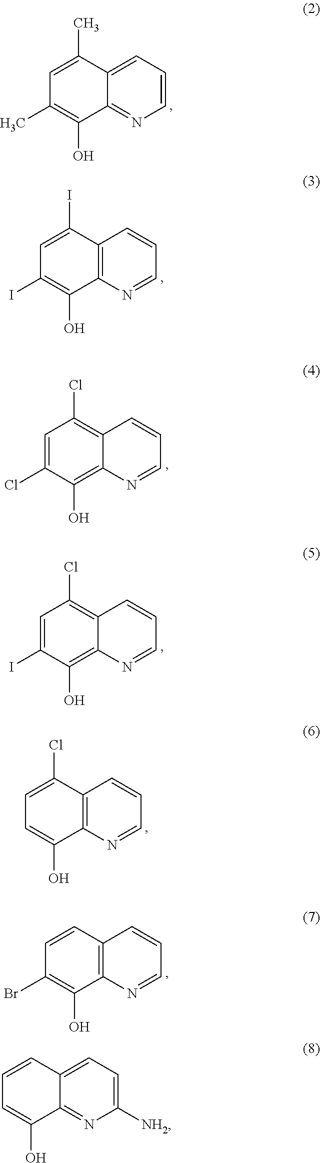

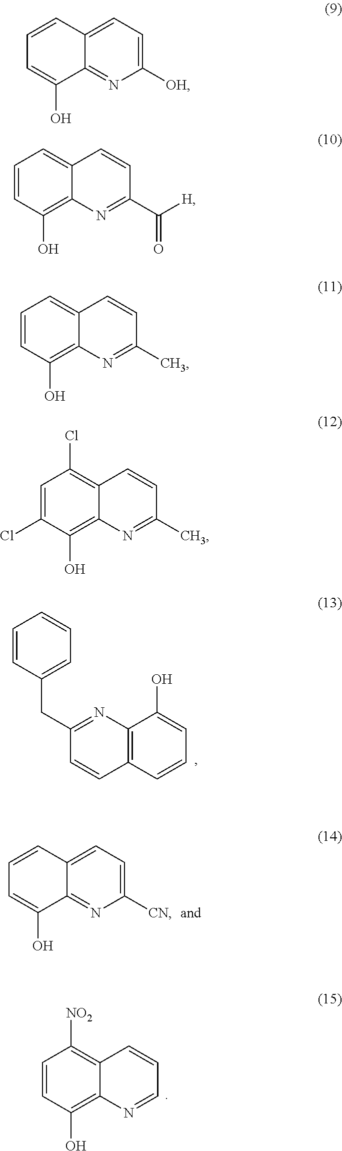

In addition, an additive of the invention may include more than one 8-hydroxyquinoline in a molecule, such as

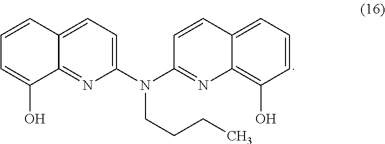 [SMILES: CCCCN(c1ccc2cccc(O)c2n1)c1ccc2cccc(O)c2n1]

As illustrated in the structure above, the additive has a conjugated system and, at the same time, it is a bi-functional hydrogen bonding molecule, which in protic solvents can act simultaneously as an H donor via the O-H group and as an H acceptor via the N atom. HQ and its derivatives are widely used as chelating reagents in analytical chemistry and radiochemistry for metal ion extraction.

In accordance with embodiments of the invention, such additives may be added to an electrolyte solution at any suitable concentrations, such as in a range of from about 0.01 wt % to about 10 wt %, preferably from about 0.01 wt % to about 3 wt %, and more preferably from about 0.1 wt % to about 1.0 wt %, wherein the wt % is based on the total weight of the electrolyte solution.

Embodiments of the invention are discussed below in more detail with examples to illustrate various aspects of the invention. One skilled in the art would appreciate that these examples are for illustration only and are not intended to limit the scope of the invention.

Preparation of 1865140-Type cell

Cathode electrode preparation: 91wt % LiFePO₄, 3.5wt % acetylene black, 0.5wt % graphite, and 5.0wt % poly-vinylidene-difluoride (PVDF) power are mixed together with N-methyl-2-pyrrolidone (NMP) to obtain a mixture, which is then coated on an aluminum foil collector. After being dried at 120 ° C., the coated aluminum foil is pressed to obtain a cathode electrode. The compacted density of the cathode electrode thus obtained is about 2.15 g/cm³.

The preparation of the anodes is similar to the method for cathode preparation described above. Briefly, 93.2wt % graphite is mixed with 2.5wt % acetylene black 2.5wt % styrene butadiene rubber (SBR) and 1.8 wt % carboxymethyl cellulose sodium (CMC) to obtain a mixture with water, which is then coated on a copper foil collector. After being dried, the coated copper foil is pressed to obtain an anode electrode. The compacted density of the anode electrode thus obtained is 1.4 g/cm³.

A Celgard 2325 microporous membrane separator was placed between the electrodes and soaked wet with the electrolyte. The cells were assembled in an Ar-filled dry box at room temperature to minimize the possibility of trapping moisture in the cells. Cell performance was evaluated by galvanostatic experiments carried out on a multichannel Xinwei battery tester (Guangzhou, China).

Water and Acid Contents After Storage at Elevated Temperatures

These tests were performed with the electrodes and cells prepared using the procedures described above. The electrolyte in each is a 1M LiPF₆ in EC/EMC/DEC (ethylene carbonate—ethylmethyl carbonate—diethyl carbonate ternary solvent system; 1:1:1 in weight ratio). In one cell, an additive (HQ) is added to the electrolyte at 0.5 wt %, while the other cell was without the additive as a control. The experiment was carried out in a sealed bottle, and the bottle is kept in a dry box with a water content of less than 5 ppm. The water and acid contents of the cells were measured before and after the cells have been kept at 45° C. for 4 days. The H₂O contents were determined with a Karl-Fisher titrator, and the HF contents were determined with acid-base titration.

TABLE 1 shows the results of these measurements.

TABLE 1

| | Without HQ | | With HQ | |
|---|---|---|---|---|
| | H₂O | | H₂O | |
| | content | HF content | content | HF content |
| Before storage at 45° C. | 17 | 14.9 | 18 | 13.1 |
| After storage at 45° C. | 97 | 93.5 | 37 | 24.5 |

As shown in TABLE 1, the H₂O contents and HF contents increased dramatically upon storing LiPF₆-based electrolytes at 45 C for 4 days. Specifically, in the absence of a stabilizer, the H₂O contents in the electrolyte increased from 17 ppm to 97 ppm, while the HF contents increased from 14.9 ppm to 93.5 ppm. (Herein, ppm corresponds to mg/Kg). However, addition of 0.5 wt % HQ effectively suppressed the formation of water and HF. Specifically, in the presence of the stabilizer, the increase in the H₂O contents in the electrolyte was substantially less (from 18 ppm to 37 ppm). Similarly, the increase in the HF contents was substantially lower (from 13.1 ppm to 24.5 ppm), in the presence of the additive (HQ). Thus, the additive HQ is an effective stabilizing agent of LiPF₆-type electrolyte and can suppress the formation of water and HF. With lower water and HF concentrations, cathode dissolution would be suppressed. Therefore, HQ or similar additives can prevent or slow degradation of the batteries.

Addition of 1.0 wt % Compound 9 or 0.2 wt % Compound 14 to 1M LiPF₆ in EC/EMC/DEC (w/w/w) had similar effects as that of HQ in the suppression of the formation of water and HF. These results indicate that compounds having the common 8-hydroxyquinoline core are sufficient to confer the stabilizing effects.

Charge and Discharge Characteristics

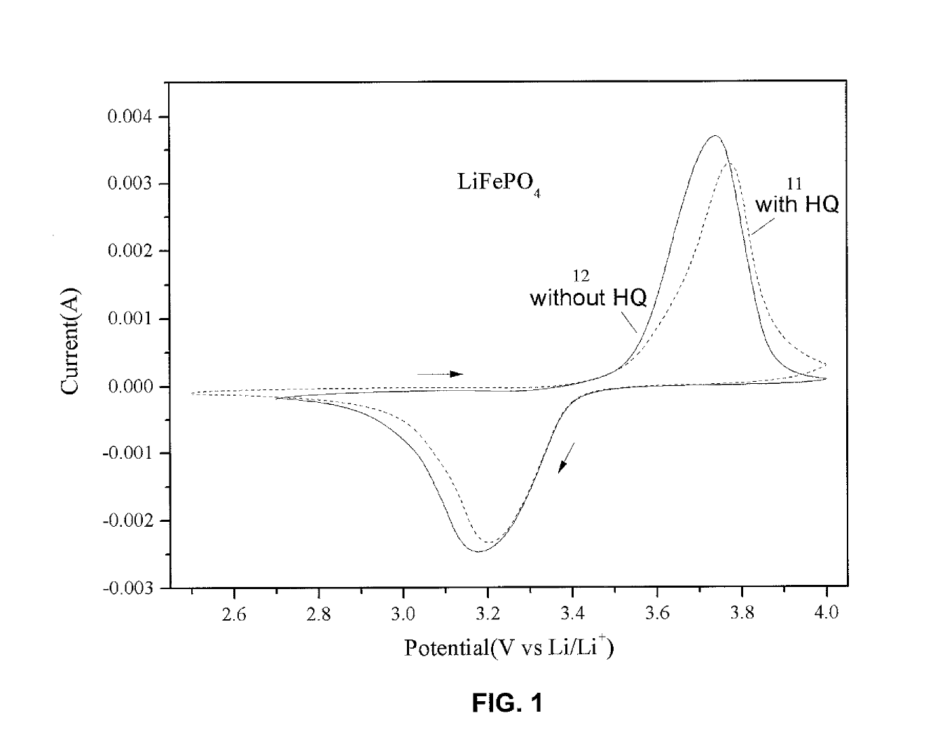

To be useful, an additive should not substantially impact the performance characteristics of a battery. To investigate the effects of additives on battery performance, two cells were prepared with the above electrodes and LiFePO₄ electrolyte (1M LiPF₆ in EC/EMC/DEC, 1:1:1 in weight ratio). To one cell was added HQ (1.0 wt %), while the other cell was kept without the additive. The charge and discharge behaviors of these cells were investigated at 25° C. with a scan rate of 0.2 mV/s. The results are shown as voltammograms in FIG. 1.

As shown in FIG. 1, HQ has little effect on the lithiation and delithiation of cathode materials (such as LiFePO₄). The potential separation between the anodic and cathodic peaks remains unchanged though the two peaks move to slightly higher potentials, when 1.0 wt % HQ was added to the electrolyte of LiFePO₄/Li half cell.

Reductive Stability

Graphite is a common material for making negative electrodes for lithium ion batteries. When a graphite electrode is polarized to negative potentials during a charging cycle, the ethylene carbonate (EC) solvent molecules may be reductively decomposed on the graphite electrode surface to form a stable film, which is referred to as a solid electrolyte interface (SEI) film. SEI film passivates the graphite surface and prevents further reductive decomposition of the solvent molecules, allowing only Li ions to migrate into and out of the graphite electrode.

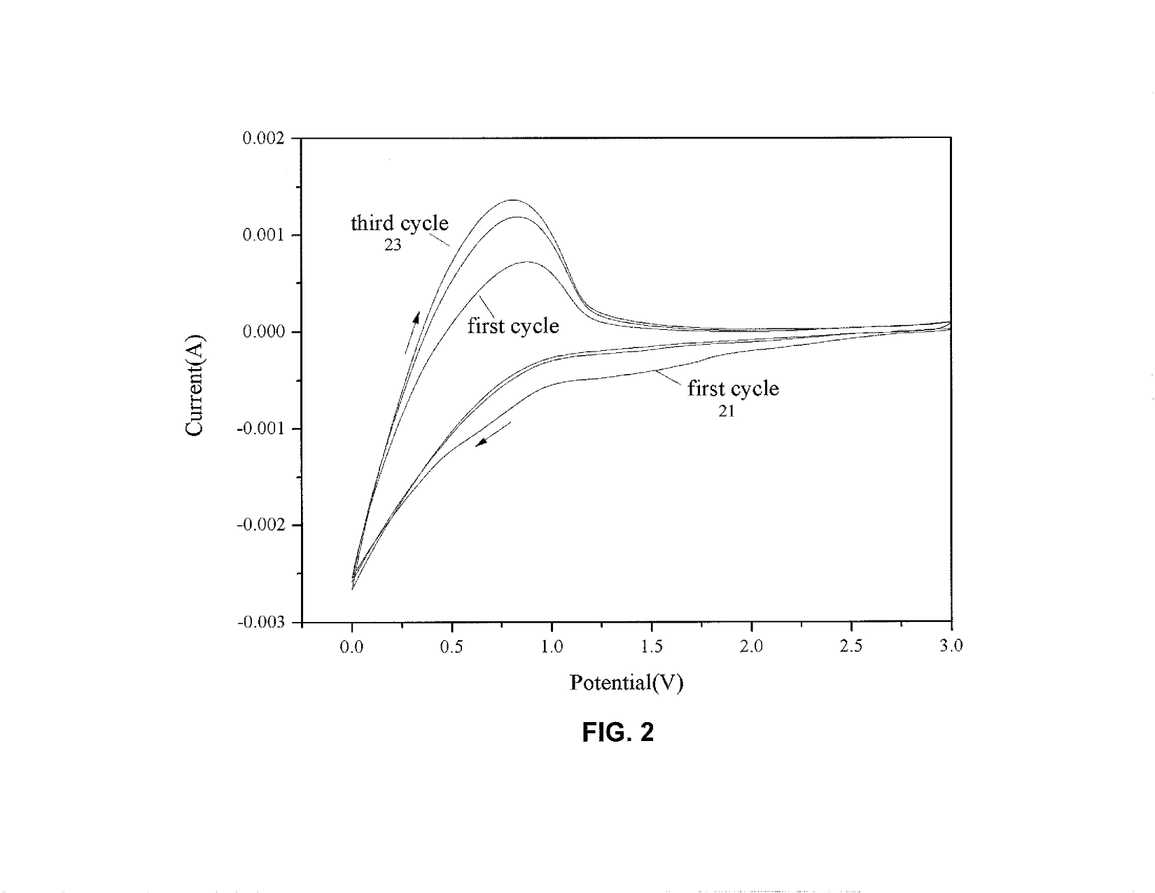

To assess whether the additive would affect this passivation process, tests were performed with 1M LiPF₆ in EC/EMC/DEC (1:1:1 in weight ratio) containing 1.0 wt % HQ (0.5 wt %) as an electrolyte, using a graphite anode prepared over a Cu substrate as a working electrode and Li as a counter and reference electrodes. The scan rate was 5 mV/s. FIG. 2 shows results of the reductive stability tests on the surface of the graphitic anode.

As shown in the cyclic voltammograms of FIG. 2, there are reductive peaks between 0.5 and 1.8 volts, which disappear in the subsequent cycles, indicating that EC reductive decomposition was completed in the first cycle. This results shows that 0.5wt % HQ has no effect on the formation of solid electrolyte interface (SET) film, indicating that HQ-contained electrolyte is compatible with graphite anodes.

Suppression of electrolyte oxidation by HQ

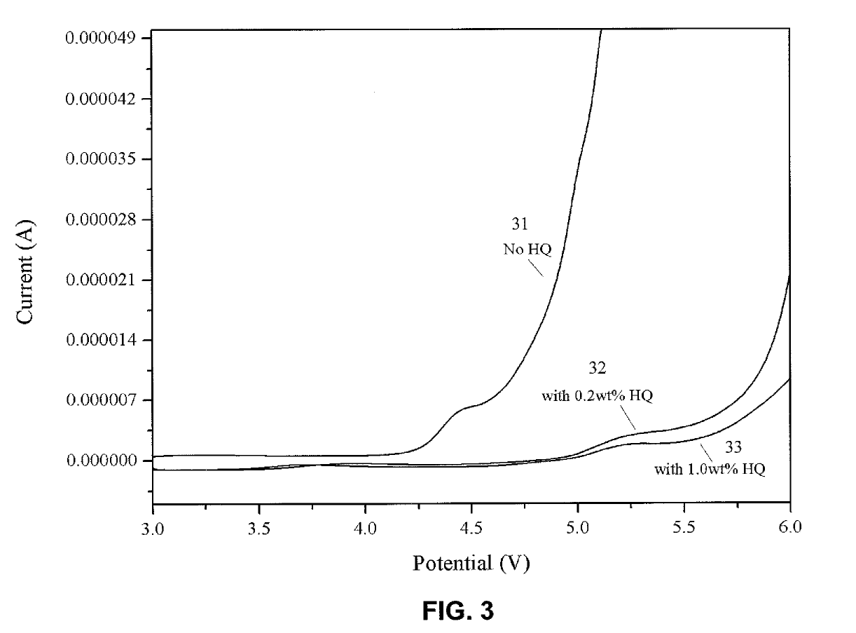

FIG. 3 shows linear sweep voltammograms of a Pt microelectrde in an electrolyte comprising 1M LiPF₆ in EC/EMC/DEC (1:1:1 in weight ratio), with or without HQ. The tests were performed at 25° C. with a scan rate of 5 mV/s. The curves (curve 31, no HQ; curve 32 with 0.2% HQ; and curve 33 with 1.0% HQ) are obtained with a Pt disk electrode as a working electrode, a Pt wire as a counter electrode, and Li as a reference electrode.

As shown in FIG. 3, in the electrolyte without HQ, oxidation current appears when the potential is swept to about 4.2V, and the oxidation current increases quickly as the potential becomes more positive, which is attributed to the oxidation of electrolyte on the Pt electrode. In contrast, in the electrolytes with HQ (0.2 wt % or 1.0 wt %), only barely detectable oxidation currents appear at about 3.5V. However, the oxidation currents increase appreciably as the potentials are swept to above 5.0V. It is apparent that the oxidative stability of the electrolyte in the presence of HQ is significantly increased. Thus, the carbonate-based electrolytes containing HQ may be used as high voltage electrolytes for high voltage materials, such as LiNi_{0.5}Mn_{1.5}O₄, LiCoPO₄, and the like.

Prevention of Capacity Fading over High Voltage by HQ

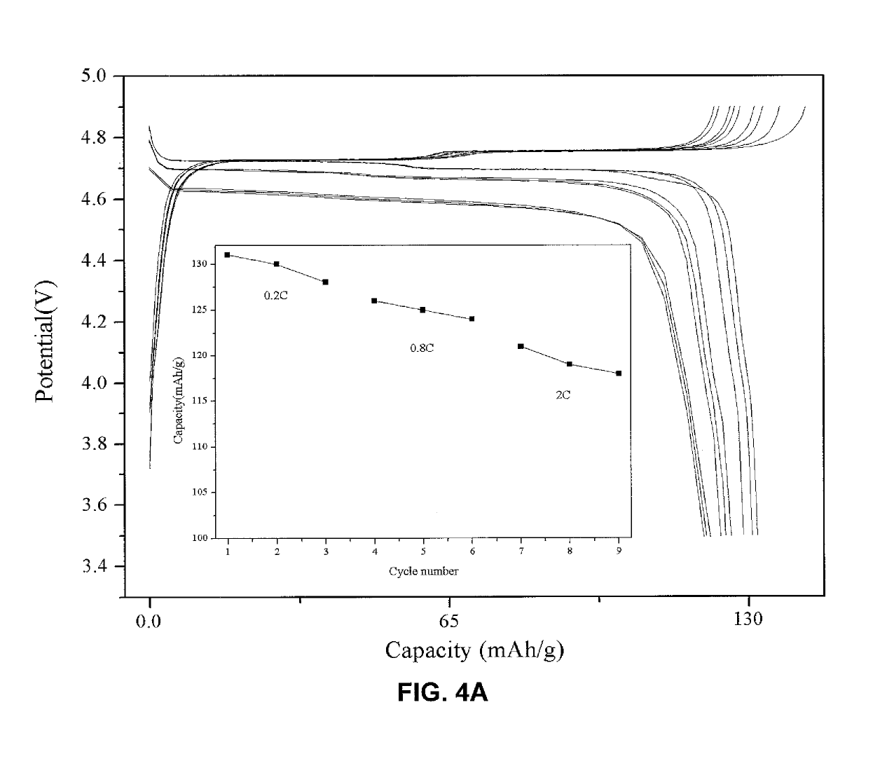

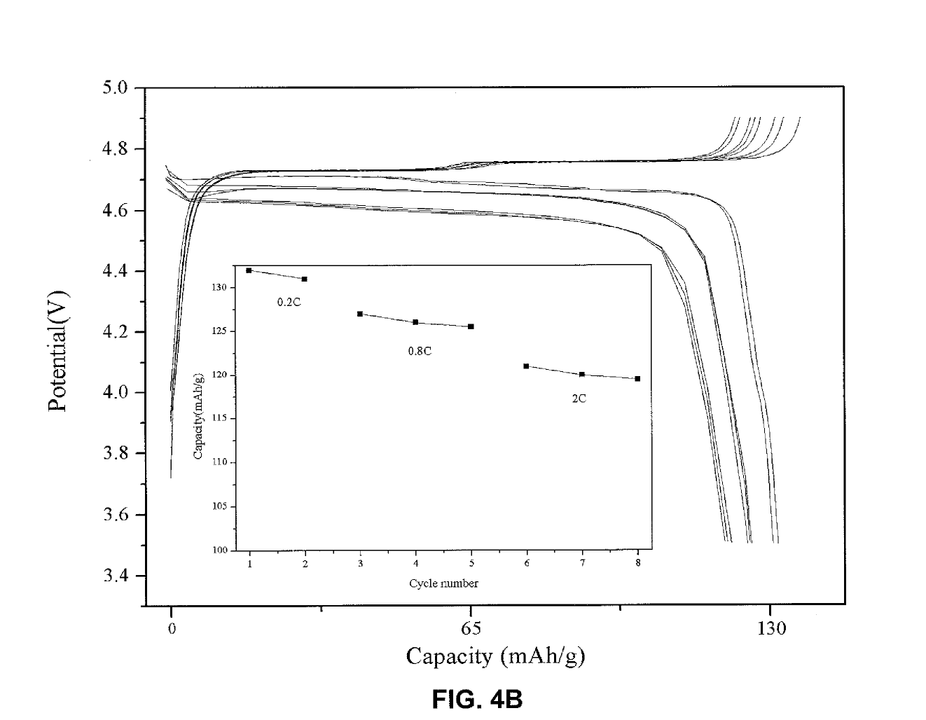

FIG. 4A and FIG. 4B show results of charge-discharge of LiNi_{0.5}Mn_{1.5}O₄//Li half cell. The half cells are charged at a rate of 0.2 C and discharged at rates of 0.2C, 0.8C and 2C, respectively, in a voltage range of 3.5-4.9 V.

FIG. 4A shows the charge-discharge curves of LiNi_{0.5}Mm₅O₄//Li half cell in 1M

LiPF₆ in EC/EMC/DEC (1:1:1 in weight), and FIG. 4B shows the charge-discharge curves in 1M LiPF₆ in EC/EMC/DEC (1:1:1 in weight) with 0.5 wt % HQ.

A comparison between the results in FIG. 4A and FIG. 4B revealed that with only 0.5wt % HQ present in the baseline electrolyte, the capacity fading between charging and discharging profiles were minimized. Although the capacity fading still exists with HQ-presence, there is a significant improvement in capacity fading at high voltage, as compared with the baseline electrolyte without the additive.

Battery Cycle Performance

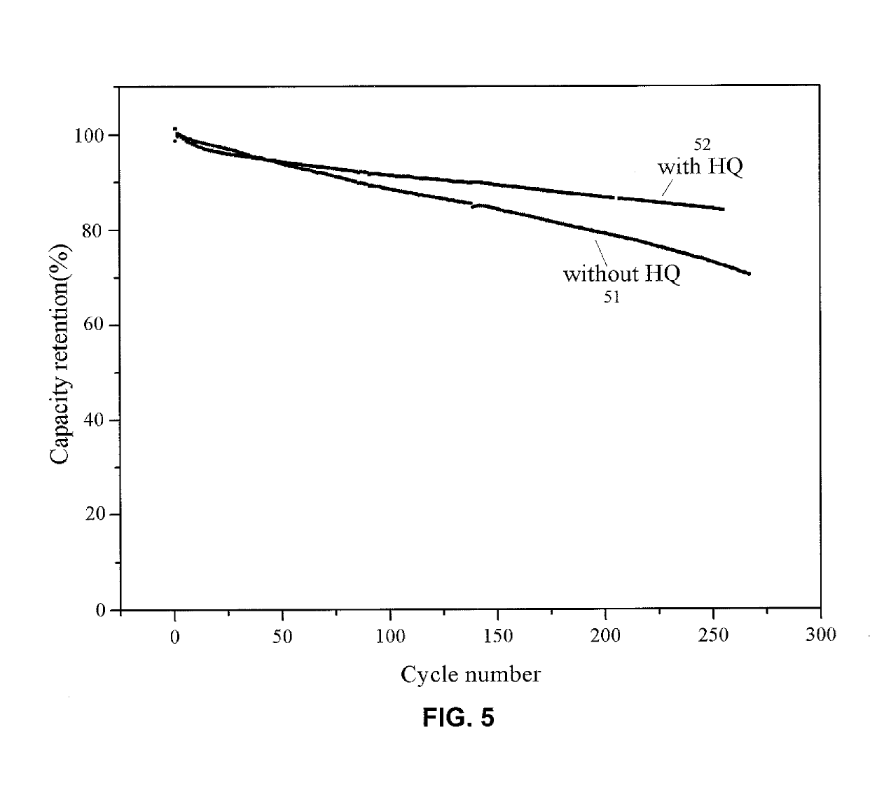

In order to assess the influence of additive on the battery cycle performance, the inventors investigated the cycle life of cells with 1M LiPF₆ in EC/EMC/DEC/VC/1,3-PS (1:1:1:0.1:0.05 in weight ratio) electrolyte containing 0.2 wt.% HQ, as compared with cells without the additive. In these tests, LiFePO₄/graphite 1865140 10 Ah winding square cells were used and the tests conducted within 2-3.65 V at 60+2° C. (C/2 charge and discharge). FIG. 5 shows results of the cycle life performance tests of a cell with 0.2wt % HQ (curve 52) and a cell without the additive (curve 51).

As shown in FIG. 5, after 256 cycles at 60±2° C.(C/2 charge and discharge), the capacity retention decreased to 72.0% in the cell having the electrolyte without HQ. However, the capacity retention is improved (84.7% after more than 250 cycles) in the cell with the electrolyte containing 0.2 wt % HQ. Therefore, even with a small amount of HQ additive, the high temperature cycle proceeds with much higher capacity preservation than the electrolyte without the additive.

More importantly, the addition of HQ in the electrolyte has no detectable effect on the room temperature cycle performance of the 1865140-square cell.

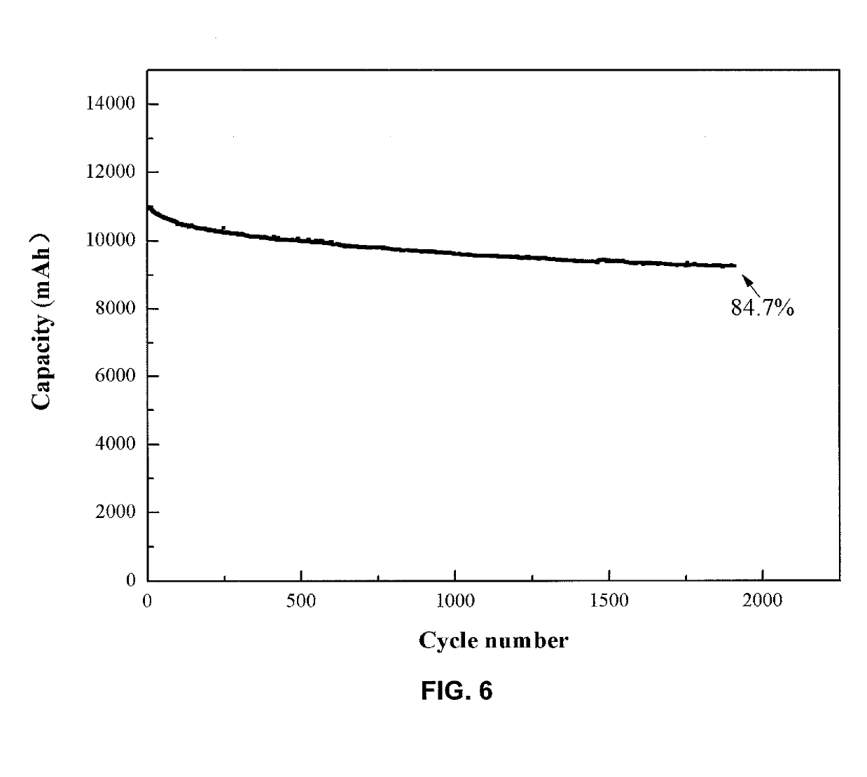

As shown in FIG. 6, the capacity retention efficiency of cell containing 0.2wt %

HQ in the electrolyte was 84.7% after 1930 cycles within 2-3.65 V at 23±2° C.(C/2 charge and discharge). This result shows that the additive helps the battery retain the capacity after repetitive charge-discharge cycles.

In addition, 1M LiPF₆ in EC/EMC/DEC/VC/1,3-PS (1:1:1:0.1:0.05 in weight ratio) electrolyte with 0.5 wt % Compound 14 was also good for improving the cycle performance at elevated temperatures. After 256 cycles at 60±2° C. (C/2 charge and discharge), the capacity retention of LiFePO₄/graphite 1865140 10 Ah cell was 87.0%. For this compound, —CN may work synergistically to reduce the content of water and HF with following ways:

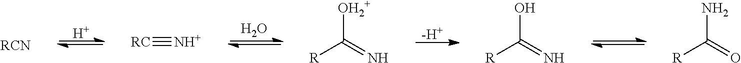

The above examples clearly show that additives having an oxine-like structure may be added to electrolytes of lithium ion batteries to improve their high temperature cycle performance and that for these oxine-like compounds, a common core containing an 8-hydroxy-quinoline moiety would be sufficient to confer the stabilizing effects. For example, with graphite or Li metal as an anodic material, LiFePO₄ or LiNi_{0.5}Mn_{1.5}O₄ as a cathodic material, 8-hydroxyquinoline has shown to improve the stability of LiPF₆ and enhance the anti-oxidative stability of carbonate-based electrolytes.

The oxine-like compounds have a hydroxyl function connected to an amino group via a conjugated system. These compounds include 8-hydroxyquinolinine and analogs thereof. The stabilizers can form hydrogen bond interactions with water molecules. Because these stabilizers have bifunctional hydrogen bonding moieties, they can form stable interactions with a water molecule to sequester it from reacting with electrolyte molecules. Therefore, the formation of HF from electrolyte is substantially suppressed or slowed. As a result, the lithium ion batteries can have improved performance, as evidenced by improved long term performance and repetitive charge-discharge performance.

Embodiments of the invention therefore constitute a promising alternative strategy for achieving good cycle performance of lithium ion batteries, particularly when operated at high temperatures or high voltage.

While this invention has been described in terms of certain embodiments thereof, it is not intended that it be limited to the above description, but rather only to the extent set forth in the following claims. The embodiments of the invention in which an exclusive property or privilege is claimed are defined in the following claims.

What is claimed is:

1. A lithium ion battery comprising:
a first electrode made of a cathodic material;
a second electrode made of an anodic material;
an electrolyte solution; and
an additive added to the electrolyte solution, wherein the additive comprises a conjugated system and a bifunctional hydrogen bonding moiety.

2. The lithium ion battery according to claim 1, wherein the additive comprises a —OH group and an N atom

3. The lithium ion battery according to claim 1, wherein the additive has the following structure: 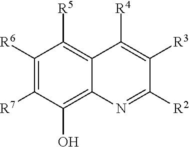
wherein R², R³, R⁴, R⁵, R⁶, and R⁷ are each independently selected from H, halogen, —OH, —NH₂, —NO₂, —CN, —CHO, —Si(CH₃)₃, —NH-alkyl, —O-alkyl or an alkyl, wherein the alkyl group is C₁-C₁₂ alkyl; preferably, C₁-C₆ alkyl; more preferably C₁-C₃ alkyl; and wherein the alkyl group may be optionally substituted with one or more substituents selected from —OH, −NH₂, —NO₂, —CN, —CHO.

4. The lithium ion battery according to claim 1, wherein the additive is one selected from the following:

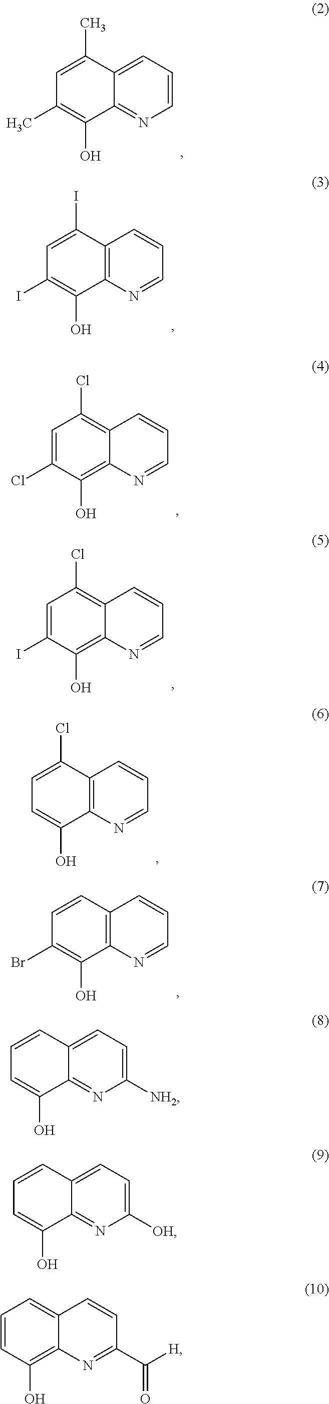

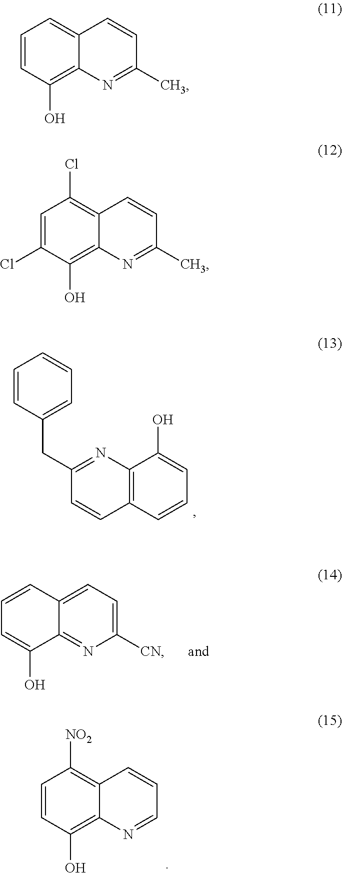 [SMILES: Cc1ccc2cccc(O)c2n1 ; Cc1ccc2c(Cl)cc(Cl)c(O)c2n1 ; Oc1cccc2ccc(Cc3ccccc3)nc12 ; N#Cc1ccc2cccc(O)c2n1 ; "and" ; O=[N+]([O-])c1ccc(O)c2ncccc12]

5. The lithium ion battery according to claim 1, wherein the additive is:

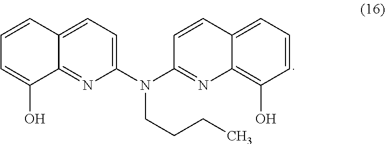 [SMILES: CCCCN(c1ccc2cccc(O)c2n1)c1ccc2cccc(O)c2n1]

6. The lithium ion battery according to claim 1, wherein said additive is 8-hydroxyquinoline.

7. The lithium ion battery according to claim 1, wherein the electrolyte solution comprises LiPF₆ or LiBF₄.

8. The lithium ion battery according to claim 1, wherein the electrolyte solution comprises a carbonate solvent.

9. The lithium ion battery according to claim 1, wherein a concentration of the additive in the electrolyte solution is in a range of about 0.01 wt % to 10 wt %.

10. The lithium ion battery according to claim 1, wherein a concentration of the additive in the electrolyte solution is in a range of about 0.01 wt % to 3 wt %.

11. The lithium ion battery according to claim 1, wherein a concentration of the additive in the electrolyte is in a range of about 0.1 wt % to 1.0 wt %.
